(19) United States
(12) Patent Application Publication
(10) Pub. No.: US 2015/0106214 A1
(43) Pub. Date: Apr. 16, 2015

(54) PROCESSING DEVICE

(71) Applicant: FUJI XEROX CO., LTD., Tokyo (JP)

(72) Inventor: Fumio SUZUKI, Yokohama-shi (JP)

(73) Assignee: FUJI XEROX CO., LTD., Tokyo (JP)

(21) Appl. No.: 14/277,152

(22) Filed: May 14, 2014

(30) Foreign Application Priority Data
Oct. 10, 2013 (JP) 2013-212822

(51) Int. Cl. G06Q 20/20

(52) U.S. Cl. CPC G06Q 20/20
USPC 705/16

(57) ABSTRACT

A processing device includes a processing section that performs a processing operation in accordance with an operation by a user; a charging section that accepts payment of a charge in accordance with a use of the processing section, and that, as a result of a returning operation after the use of the processing section, returns change or the cash replacement card after the acceptance of the payment of the charge; a human sensor that detects entry of the user into and leaving of the user from a predetermined close area; and a controller that, if the human sensor detects the leaving of the user from the close area without the returning operation being performed, prohibits the use of the processing section and removal of the change or the cash replacement card to be returned when the change or the cash replacement card to be returned exists.

### CROSS-REFERENCE TO RELATED APPLICATIONS

This application is based on and claims priority under 35 USC 119 from Japanese Patent Application No. 2013-212822 filed Oct. 10, 2013.

### BACKGROUND

The present invention relates to a processing device.

### SUMMARY

According to an aspect of the invention, there is provided a processing device including a processing section that, as a result of an operation by a user, performs a processing operation in accordance with the operation by the user; a charging section that, as a result of the user depositing money or inserting a cash replacement card, accepts payment of a charge in accordance with a use of the processing section, and that, as a result of a returning operation after the use of the processing section, returns change or the cash replacement card after the acceptance of the payment of the charge resulting from the use of the processing section; a human sensor that detects entry of the user into and leaving of the user from a predetermined close area; and a controller that, if the human sensor detects the leaving of the user from the close area without the returning operation being performed, prohibits the use of the processing section and prohibits removal of the change or the cash replacement card to be returned to the user when the change or the cash replacement card to be returned to the user exists.

### BRIEF DESCRIPTION OF THE DRAWINGS

An exemplary embodiment of the present invention will be described in detail based on the following figures, wherein:

FIG. 1 is a conceptual diagram of an exemplary processing device provided with a use charge payment acceptance function;

FIG. 2 is a block diagram of an internal structure of the processing device that is externally shown in FIG. 1;

FIG. 3 is a flowchart of operations that are started as a result of turning on a human sensor;

FIG. 4 is a flowchart of a processing operation that is performed as a result of operating a return button;

FIG. 5 is a flowchart of a processing operation that is performed when a first timer times up;

FIG. 6 is a flowchart of a processing operation that is performed as a result of turning off the human sensor; and

FIG. 7 is a flowchart of a processing operation that is performed when a person in charge performs a particular operation.

### DETAILED DESCRIPTION

An exemplary embodiment of the present invention is hereunder described.

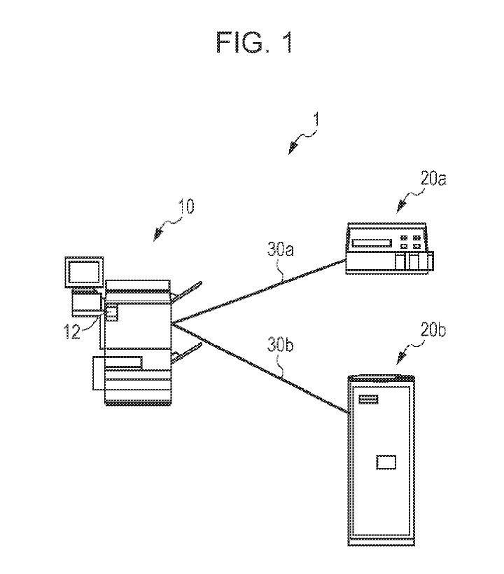

FIG. 1 is a conceptual diagram of an exemplary processing device 1 provided with a use charge payment acceptance function.

The processing device 1 includes a multifunction device 10, a card reader-writer 20a, and a coin kit 20b. The card reader-writer 20a and the coin kit 20b are connected to the multifunction device 1 by a cable 30a and a cable 30b, respectively.

The multifunction device 10 is provided with a copying function and a fax function. The multifunction device 10 is provided with a human sensor 12. The human sensor 12 is a sensor that detects that a user of the multifunction device 10 has entered a predetermined close area and that the user has left the close area. Though the principle of detection of the human sensor 12 is not questioned, for example, a pyroelectric sensor that detects infrared rays by making use of a pyroelectric effect is suitable for the human sensor 2. Alternatively, the human sensor 2 may be one that includes a camera and that detects the approach of a human being on the basis of image analysis.

The card reader-writer 20a is capable of accepting payment of a charge resulting from use of the multifunction device 10 and allows access to a cash replacement card, such as an IC card or a prepaid card, which has been inserted. A user of the multifunction device 10 inserts a necessary card from a card insertion opening of the card reader-writer 20a. This causes the card reader-writer 20a to check whether or not the inserted card is a card that is capable of being handled at the card read-writer 20a. When the card is capable of being handled, the card read-writer 20a checks whether or not a balance that allows the use of the multifunction device 10 exists. If a sufficient balance exists, the card reader-writer 20 allows the use of the multifunction device 10. When the use of the multifunction device 10 ends, the charge in accordance with the use of the multifunction device 10 is subtracted. Then, the user performs an ejection operation to eject the card from the card insertion opening. The user takes the ejected card and leaves.

Coins are deposited from a coin deposit opening of the coin kit 20b. The coin kit 20b stores coins of an amount that is in accordance with the use of the multifunction device 10. The coin kit 20b is subjected to a change return operation by the user, and ejects the change from a change return opening. The user takes the ejected change, and leaves.

The processing device 1 shown in FIG. 1 includes both the card reader-writer 20a and the coin kit 20b. However, as long as a processing device includes either one of the card reader-writer 20a and the coin kit 20b, it may be used as the processing device according to the present invention. In the processing device 1 shown in FIG. 1, the multifunction device 10, the card reader-writer 20a, and the coin kit 20b are incorporated in separate housings, with the multifunction device 10 and the card reader-writer 20a being connected to each other with the cable 30a and the multifunction device 10 and the coin kit 20b being connected to each other with the cable 30b. However, these components may be incorporated in one housing.

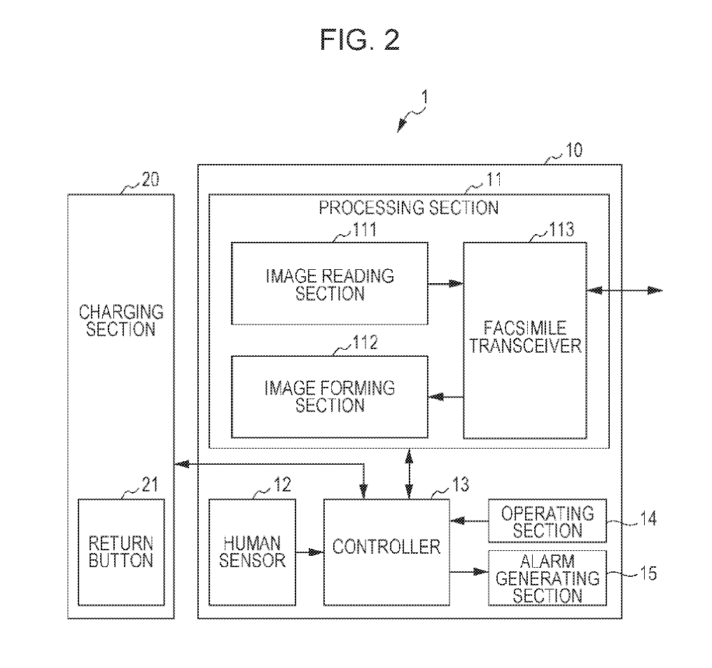

FIG. 2 is a block diagram of an internal structure of the processing device that is externally shown in FIG. 1. Here, a charging section 20 is shown as typifying the card reader-writer 20a and the coin kit 20b shown in FIG. 1.

The processing device 1 includes the multifunction device 10 shown in FIG. 1 and the charging section 20 including the card reader-writer 20a or the coin kit 20b. The multifunction device 10 includes a processing section 11, the human sensor 12, the controller 13, an operating section 14, and an alarm generating section 15.

When a user operates the processing section 11, the processing section 11 performs a processing operation in accordance with the user's operation. The processing section 11 includes an image reading section 111, an image forming section 112, and a facsimile transceiver 113.

The image reading section 111 reads an image that is recorded on an original, and generates image data that represents the image.

The image forming section 112 forms an image on a sheet on the basis of the image data. As the image forming section 112, an electrophotographic system is suitably used. However, the system is not limited to an electrophotographic system. An image may be formed by, for example, an inkjet system or a thermo-sensitive system. In the image forming section 112, it is possible to form an image based on image data obtained by reading an original at the image reading section 111. In this case, the multifunction device 10 operates as a copying machine 10. However, the image forming section 112 also forms an image based on image data received by the facsimile transceiver 113 (described below) in addition to the image data obtained by the image reading section 111.

The facsimile transceiver 113 is connected to a telephone line (not shown), and transmits and receives image data via the telephone line. In the multifunction device 10, transmission by fax is realized when image data is obtained by reading an original by the image reading section 111 and transmitting image data from the facsimile transceiver 113. In the multifunction device 10, reception by fax is realized when the facsimile transceiver 113 receives image data that has been transmitted via the telephone line and the image forming section 112 forms an image based on the received image data. That is, the processing section 11 is provided with both a copying function and a facsimile transceiver function.

As mentioned above, the human sensor 12 is a sensor that detects entry of a user into a predetermined close area and leaving of the user from the close area.

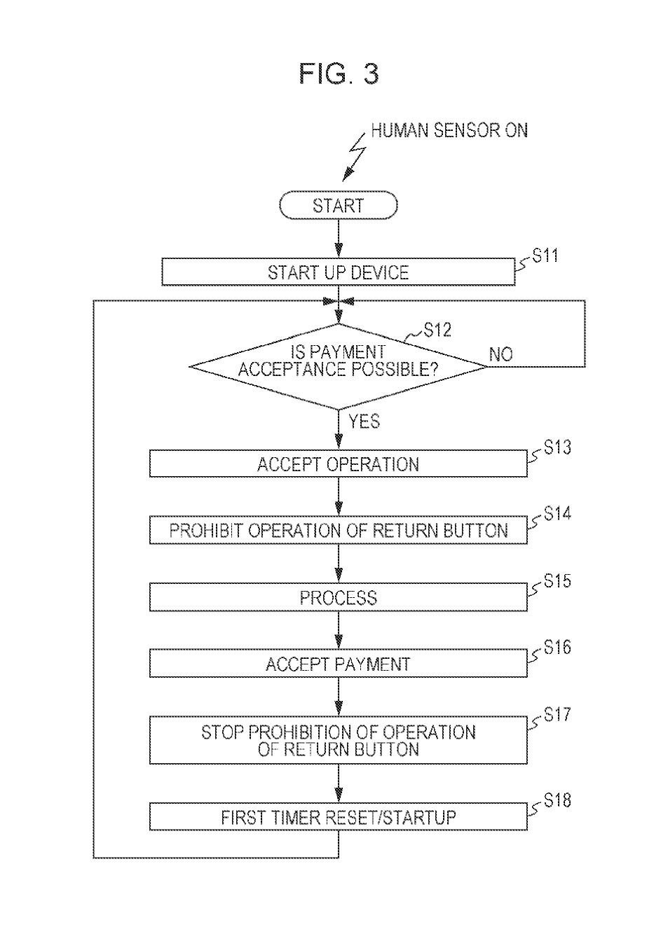

The controller 13 controls the entire processing device 1 including the processing section 11, the charging section 20, and other component parts. Characteristic controlling operations in the exemplary embodiment that are performed by the controller 13 are described with reference to FIG. 3 and the subsequent figures.

The operating section 14 is operated by the user of the processing device 1. The content of the operation at the operating section 14 is transmitted to the controller 13, and is reflected in the control of each part.

The multifunction device 10 includes the alarm generating section 15. The alarm generating section 15 is an element that issues a sound alarm to the user. The timing at which the sound alarm is issued is described with reference to FIG. 3 and the subsequent figures.

The charging section 20 represents the card reader-writer 20a and the coin kit 20b described with reference to FIG. 1. One or both of the card reader-writer 20a and the coin kit 20b may be built in the charging section 20. As shown in FIG. 1, they may be connected to the multifunction device 10 by the cables 30a and 30b, respectively, or may be integrated to the multifunction device 10.

The charging section 20 is provided with the return button 21. When the return button 21 is pressed, if the card reader-writer 20a is used, the inserted card is ejected; and, if the coin kit 20b is used, any change to be returned is ejected.

Next, the operation of the processing device 1 is described.

FIG. 3 is a flowchart of operations that are started when the human sensor is turned on.

During standby, electric power is only supplied to the human sensor 12 and other necessary component parts. When the human sensor 12 is turned on, that is, when it is detected that a person has entered the predetermined close area, electric power is supplied to each part of the processing device 1, and the processing device 1 is started up so as to be in a usable state (Step S11). Then, a change to a charge payment acceptable state is monitored. The term “charge payment acceptable state” refers to a state in which it is possible to accept payment of a charge resulting from the use of the processing device 1, when, for example, a card is inserted into the card reader-writer 20a (see FIG. 1) and a balance exists in the card, or when coins are deposited into the coin kit 20b.

When the processing device 1 is started up so as to be in a usable state (Step S11) and payment of a charge is acceptable (Step S12), the operating section 14 (see FIG. 2) accepts operation by the user (Step S13).

When the operating section 14 is operated, an operation of the return button 21 (see FIG. 2) is temporarily prohibited (Step S14). This is to prevent the card or change from being ejected even if the return button 21 is operated during a processing operation.

Next, the processing operation is executed (Step S15). Here, the term “processing operation” refers to that in accordance with the operation of the user in Step S13. For example, when the user gives an instruction to perform transmission by fax by operating the operating section 14, the transmission by fax is performed in Step S16. Alternatively, when the user gives an instruction to copy something, this something is copied in Step S16.

When the processing operation is performed (Step S15), the payment of the charge is accepted in accordance with this processing operation (Step S16), and the prohibition of the operation of the return button 21 performed in Step S15 is stopped (Step S17). Then, the first timer is temporarily reset, and is started (Step S18). The first timer measures the time until the state of the device that has been started up in Step S11 is changed to a standby state (see FIG. 5). Since the first timer is reset each time a new processing operation is performed in Step S15, the time is measured from the end of the last processing operation by the user. Then, the process returns to Step S12. If the charge payment acceptable state continues, the next operation is accepted (Step S13).

If, for example, an instruction is given to copy 10 sheets (Step S13), and copying operations are performed (Step S15), when it becomes impossible to accept payment during the processing operation, such as when coins are no longer left when five sheets have been copied, an error operation that discontinues the processing operation is performed. Here, the error operation is neither illustrated nor described.

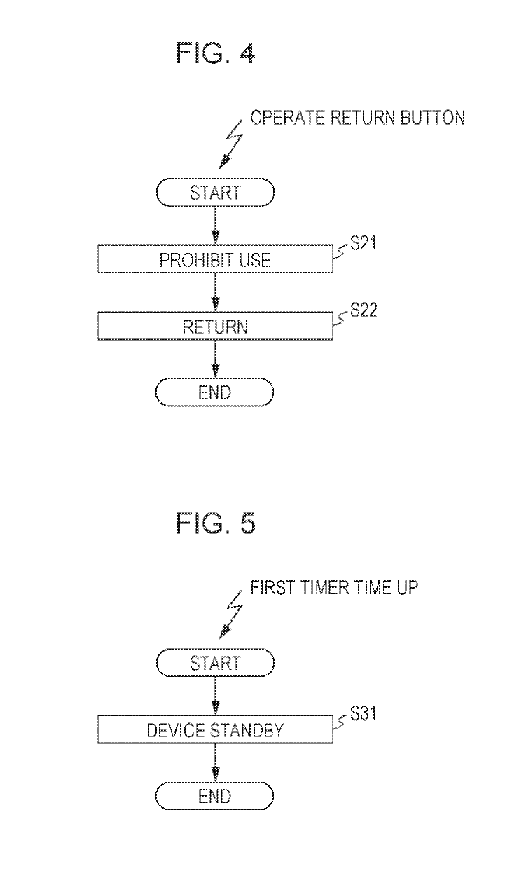

FIG. 4 is a flowchart of a processing operation that is performed when the return button is operated. When the return button 21 is operated, the subsequent use of the processing device 1 is prohibited (Step S21) and the card or change is returned (Step S22). As mentioned above, the operation of the return button is prohibited during the processing operation.

FIG. 5 is a flowchart of a processing operation that is performed when the first timer times up.

When the first timer that has been started in Step S18 in FIG. 3 times up, the state of the processing device 1 is changed to the standby state, and minimum electric power is consumed.

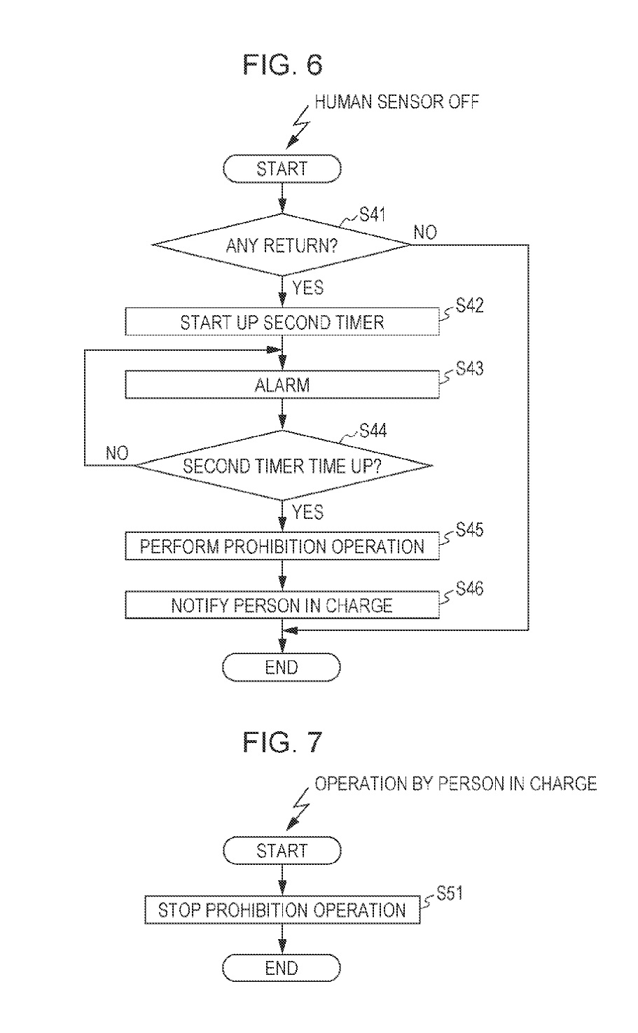

FIG. 6 is a flowchart of a processing operation that is performed when the human sensor is turned off.

When the human sensor 12 is off, that is, when the user leaves the close area of the processing device 1, the processing operation shown in FIG. 6 is performed. Here, first, it is determined whether there is a card or change to be returned to the user (Step S41). If there is no card or change to be returned, this processing operation ends.

When there is a card or change to be returned to the user, first, the second timer is started (Step S42), and a sound alarm is issued from the alarm generating section 15 shown in FIG. 2 (Step S43). The sound alarm is an alarm that notifies the user leaving the close area that there is a card or change to be returned to the user. The second timer that is started in Step S42 is a timer for dividing the time in which the sound alarm is issued.

The sound alarm continues until the second timer times up (Step S44). When the second timer times up, a prohibition operation is executed (Step S45). The term “prohibition operation” refers to an operation in which the processing device 1 does not respond to any operation performed on the processing device 1 by a general user. This operation does not allow the use of the multifunction device 10 or the taking out of a card or change in the charging section 20.

Here, as a result of performing the prohibition operation, a person in charge is notified that the prohibition operation has been performed (Step S46). The method of notifying the person in charge is not particularly limited. When the person in charge is in a shop where the processing device 1 is installed, the person in charge may be notified by, for example, a specific melody or a chime. When the person in charge is at a remote place, the person in charge may be notified via a telephone line that is connected.

FIG. 7 is a flowchart of a processing operation that is executed when a person in charge performs a particular operation after the prohibition operation has been performed in Step S45 in FIG. 6.

The operation that is performed here is an operation that is characteristic of the person in charge. Examples of the operation that is characteristic of the person in charge include an operation of a button only known by the person in charge, an operation whose procedure is only known by the person in charge, and input of a password or the like. Alternatively, the operation that is characteristic of the person in charge may be an operation that uses a key in the charge of the person in charge.

When the person in charge performs a particular operation, the processing operation in FIG. 7 is performed. Here, the prohibition operation that has been performed in Step S45 in FIG. 6 is stopped. The card or change left by a previous user is taken by the person in charge, and the person in charge temporarily keeps it. The processing device 1 is restored to the state in which the processing operation shown in FIG. 3 is performed.

According to the exemplary embodiment above, it is possible to effectively prevent a state in which a card or change forgotten by a user is used by the next user.

Here, the processing device 1 including the multifunction device 10 provided with both a copying function and a facsimile function is described. However, the processing device according to the present invention may be a processing device only provided with either a copying function or a facsimile function. Alternatively, the processing device according to the present invention is not limited to one that is provided with a copying function and a facsimile function. The processing device is one that allows a user to perform a processing operation and charges the user in accordance with the use of the processing device. For example, it is possible for a personal computer connected to the internet to be the processing device that accepts payment of a charge in accordance with the time of use of the internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing device comprising:
a processing section that, as a result of an operation by a user, performs a processing operation in accordance with the operation by the user;
a charging section that, as a result of the user depositing money or inserting a cash replacement card, accepts payment of a charge in accordance with a use of the processing section, and that, as a result of a returning operation after the use of the processing section, returns change or the cash replacement card after the acceptance of the payment of the charge resulting from the use of the processing section;
a human sensor that detects entry of the user into and leaving of the user from a predetermined close area; and
a controller that, if the human sensor detects the leaving of the user from the close area without the returning operation being performed, prohibits the use of the processing section and prohibits removal of the change or the cash replacement card to be returned to the user when the change or the cash replacement card to be returned to the user exists.

2. The processing device according to claim 1, wherein the controller prohibits the use of the processing section and the removal of the change or the cash replacement card to be returned when a predetermined time passes from the detection of the leaving of the user from the predetermined close area.

3. The processing device according to claim 2, further comprising an alarm generating section that issues an alarm, wherein, when the controller detects the leaving of the user from the predetermined close area without the returning operation being performed, the controller causes the alarm generating section to generate the alarm.

4. The processing device according to claim 1, wherein, after prohibiting the use of the processing section and the removal of the change or the cash replacement card to be returned, the controller stops the prohibitions as a result of a predetermined operation by a person in charge.

5. The processing device according to claim 2, wherein, after prohibiting the use of the processing section and the removal of the change or the cash replacement card to be returned, the controller stops the prohibitions as a result of a predetermined operation by a person in charge.

6. The processing device according to claim 3, wherein, after prohibiting the use of the processing section and the removal of the change or the cash replacement card to be returned, the controller stops the prohibitions as a result of a predetermined operation by a person in charge.

7. The processing device according to claim 1, wherein the controller performs at least one of a copying of an image on an original and a facsimile transmission of the image on the original.

8. The processing device according to claim 2, wherein the controller performs at least one of a copying of an image on an original and a facsimile transmission of the image on the original.

9. The processing device according to claim 3, wherein the controller performs at least one of a copying of an image on an original and a facsimile transmission of the image on the original.

10. The processing device according to claim 4, wherein the controller performs at least one of a copying of an image on an original and a facsimile transmission of the image on the original.

11. The processing device according to claim 5, wherein the controller performs at least one of a copying of an image on an original and a facsimile transmission of the image on the original.

12. The processing device according to claim 6, wherein the controller performs at least one of a copying of an image on an original and a facsimile transmission of the image on the original.
